(19) United States
(12) Patent Application Publication
(10) Pub. No.: US 2026/0095991 A1
(43) Pub. Date: Apr. 2, 2026

(54) LIGHT-EMITTING DIODE LIGHT SOURCE DEVICE AND DRIVING METHOD THEREOF

(71) Applicant: Bridgelux Optoelectronics (Xiamen) Co., Ltd., Xiamen (CN)

(72) Inventors: XIAOLEI ZHU, Xiamen (CN); ZHE LU, Xiamen (CN); ZHAOPAN WU, Xiamen (CN)

(21) Appl. No.: 19/002,915

(22) Filed: Dec. 27, 2024

(30) Foreign Application Priority Data
Sep. 30, 2024 (CN) 202411377298.8

(51) Int. Cl. H05B 45/59; H05B 45/20; H05B 45/325; H05B 45/46

(52) U.S. Cl. CPC H05B 45/59; H05B 45/20; H05B 45/325; H05B 45/46

(57) ABSTRACT

A LED light source device includes: a driving circuit, including: N number of driving input ends and N number of driving output ends, where the driving circuit is connected to a first power input end, and N is an integer greater than 1; and N number of LED strings of different colors, connected between a second power input end and the N number of driving output ends respectively. The driving input ends are configured to receive N number of target PWM signals respectively, to make the driving circuit drive the LED strings connected to the driving output ends to emit light and mix colors based on the target PWM signals, a sum of duty cycles of the N number of target PWM signals is greater than 1 and less than N and the duty cycle of each of at least one of the target PWM signals is 1.

### CROSS-REFERENCE TO RELATED APPLICATION

This application claims priority to Chinese Patent Application No. 202411377298.8, filed on Sep. 30, 2024, which is herein incorporated by reference in its entirety.

### TECHNICAL FIELD

The disclosure relates to the field of light source technologies, and more particularly to a light-emitting diode (LED) light source device and a driving method of the LED light source device.

### BACKGROUND

Existing color or color temperature (also referred to as correlated color temperature, abbreviated as CCT) adjustments include two types: one is a dual inline package (DIP)-switch adjustment, and the other is a pulse-width modulation (PWM) signal adjustment. The PWM signal adjustment is achieved by regulating duty cycles of PWM signals, which usually encounters the problem of flicker. The problem of flicker of light can cause eye fatigue, and long-term exposure to a flicker environment can lead to a decline in vision, visual fatigue, dry eye syndrome, and keratitis. The problem of flicker can also disrupt attention, increase anxiety, and trigger headaches and other diseases.

Therefore, how to avoid the problem of flicker that arises from the PWM signal adjustment is an urgent technical issue that needs to be solved.

### SUMMARY

In view of the foregoing, embodiments of the disclosure provide a LED light source device and a driving method of a LED light source device, which can effectively solve the problem of flicker occurred on a PWM signal adjustment.

Specifically, in an aspect, an embodiment of the disclosure provides the LED light source device. The LED light source device includes: a driving circuit and N number of LED strings of different colors. The driving circuit includes N number of driving input ends, and N number of driving output ends, the driving circuit is connected to a first power input end, and N is an integer greater than 1. The N number of LED strings are connected between a second power input end and the N number of driving output ends respectively. Moreover, the N number of driving input ends are configured to receive N number of target PWM signals respectively, to thereby make the driving circuit, based on the N number of target PWM signals, drive the N number of LED strings of different colors respectively connected to the N number of driving output ends to emit light for color mixing, a sum of duty cycles of the respective N number of target PWM signals is greater than 1 and less than N, and the duty cycle of each of at least one of the N number of target PWM signals is 1.

In another aspect, an embodiment of the disclosure provides the driving method of the LED light source device. The LED light source device includes N number of LED strings of different colors, and N is an integer greater than 1. The driving method includes:
receiving N number of target PWM signals, where a duty cycle of each of at least one of the N number of target PWM signals is 1, and a sum of duty cycles of the respective N number of target PWM signals is greater than 1 and less than N; and
driving, based on the N number of target PWM signals, the N number of LED strings of different colors to emit light and for color mixing, respectively.

The above embodiments of the disclosure have the following beneficial effects.

The duty cycle of each of at least one of the N number of target PWM signals configured to respectively drive the N number of LED strings is set to 1, and the sum of the duty cycles of the respective N number of target PWM signals is greater than 1 and less than N. In this way, within a single cycle, the N number of LED strings may have a state of being lit up simultaneously, and has no state where all the N number of LED strings are off simultaneously, thus solving the problem of flicker of the PWM signal adjustment.

### BRIEF DESCRIPTION OF DRAWINGS

Specific embodiments of the disclosure are described in detail below with reference to the accompanying drawings.

FIG. 1A illustrates a schematic diagram of a component connection relationship of a LED light source device in the related art.

FIG. 1B illustrates a waveform diagram of multiple PWM signals used by the LED light source device illustrated in FIG. 1A.

FIG. 2A illustrates a schematic diagram of a first component connection relationship of a LED light source device according to an embodiment of the disclosure.

FIG. 2B illustrates a waveform diagram of multiple PWM signals used by the LED light source device illustrated in FIG. 2A.

FIG. 3 illustrates a schematic diagram of a second component connection relationship of the LED light source device according to the embodiment of the disclosure.

FIG. 4 illustrates a schematic diagram of a third component connection relationship of the LED light source device according to the embodiment of the disclosure.

FIG. 5 illustrates a schematic diagram of a fourth component connection relationship of the LED light source device according to the embodiment of the disclosure.

FIG. 6 illustrates a schematic diagram of a fifth component connection relationship of the LED light source device according to the embodiment of the disclosure.

FIG. 7 illustrates a schematic diagram of a sixth component connection relationship of the LED light source device according to the embodiment of the disclosure.

FIG. 8 illustrates a schematic diagram of a seventh component connection relationship of the LED light source device according to the embodiment of the disclosure.

FIG. 9 illustrates a schematic diagram of an eighth component connection relationship of the LED light source device according to the embodiment of the disclosure.

FIG. 10 illustrates a schematic diagram of a ninth component connection relationship of the LED light source device according to the embodiment of the disclosure.

### DETAILED DESCRIPTION OF EMBODIMENTS

In order to make the above purposes, features, and advantages of the present disclosure more apparent and understandable, specific embodiments of the present disclosure are described in detail below in conjunction with the accompanying drawings.

In order to enable those skilled in the art to better understand technical solutions of the present disclosure, a clear and complete description of the technical solutions in the embodiments of the present disclosure is provided below in conjunction with the accompanying drawings. Apparently, the described embodiments are only a part of the embodiments of the present disclosure, not all of them. Based on the embodiments of the present disclosure, all other embodiments obtained by those skilled in the art without creative labor should fall within the scope of protection of the present disclosure.

It should be noted that the terms “first” and “second” etc., in the specification and claims and the accompanying drawings of the present disclosure are used to distinguish similar objects and do not necessarily need to be used to describe a specific order or sequence. It should be understood that the terms used in this way may be interchangeable in appropriate circumstances, so that the embodiments of the present disclosure described herein can be implemented in order other than those illustrated or described herein. In addition, the terms “including” and “having”, as well as any variations thereof, are intended to cover non-exclusive inclusions, such as processes, methods, systems, products, or devices that contain a series of steps or units that are not necessarily limited to those clearly listed, but may include other steps or units that are not clearly listed or inherent to these processes, methods, products, or devices.

It should be noted that the division of multiple embodiments in the present disclosure is only for the convenience of description and should not constitute a special limitation. The features of various embodiments can be combined and referenced to each other without contradiction.

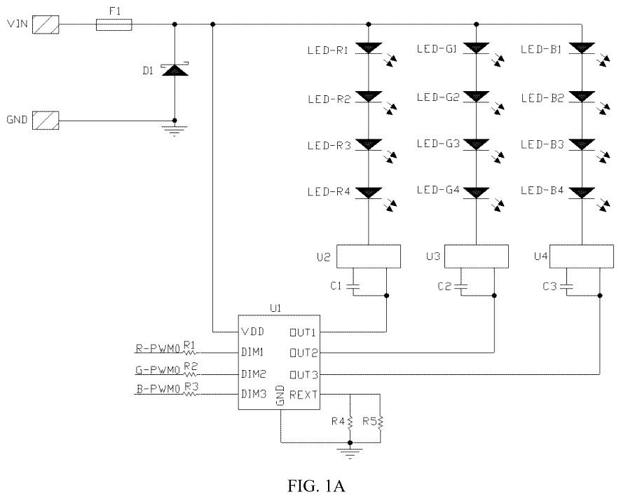

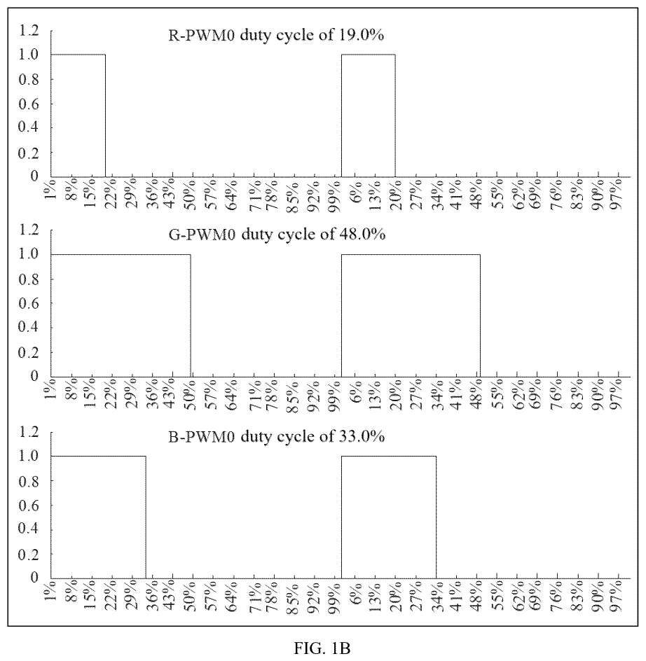

As shown in FIG. 1A, in the related art, a LED light source device includes: a red LED string, a green LED string, a blue LED string, a driving chip U1, a Zener diode (also referred to as a voltage regulator diode) D1, a fuse F1, and multiple flicker reduction circuits. Input pins DIM1, DIM2 and DIM3 of the driving chip U1 are connected to resistors R1, R2 and R3 respectively, and configured to receive PWM signals R-PWM0, G-PWM0 and B-PWM0. A first one of the multiple flicker reduction circuits includes a flicker reduction chip U2 and a capacitor C1 connected to the flicker reduction chip U2. A second one of the multiple flicker reduction circuits includes a flicker reduction chip U3 and a capacitor C2 connected to the flicker reduction chip U3. A third one of the multiple flicker reduction circuits includes a flicker reduction chip U4 and a capacitor C3 connected to the flicker reduction chip U4. The red LED string includes red LEDs LED-R1, LED-R2, LED-R3, and LED-R4 connected in series. An end of the red LED string is connected to a power input end VIN through the fuse F1, and another end of the red LED string is connected to an output pin OUT1 of the driving chip U1 through a corresponding one of the multiple flicker reduction circuits. The green LED string includes green LEDs LED-G1, LED-G2, LED-G3, and LED-G4 connected in series. An end of the green LED string is connected to the power input end VIN through the fuse F1, and another end of the green LED string is connected to an output pin OUT2 of the driving chip U1 through a corresponding one of the multiple flicker reduction circuits. The blue LED string includes blue LEDs LED-B1, LED-B2, LED-B3, and LED-B4 connected in series. An end of the blue LED string is connected to the power input end VIN through the fuse F1, and another end of the blue LED string is connected to an output pin OUT3 of the driving chip U1 through a corresponding one of the multiple flicker reduction circuits. Moreover, an external resistor connection pin REXT of the driving chip U1 is connected to a power input end GND, i.e., grounded, through resistors R4 and R5 connected in parallel. A power supply end VDD of the driving chip U1 is connected to the power input end VIN, and a ground end GND of the driving chip U1 is connected to the power input end GND. An end of the Zener diode D1 is connected to the power input end GND, and another end of the Zener diode D1 is connected to the power input end VIN through the fuse F1.

TABLE 1
mapping relationship table between PWM signal
duty cycles and mixed CCTs

| | Mixed CCT | | | | |
|---|---|---|---|---|---|
| PWM signal | 2700K | 3000K | 4000K | 5000K | 6500K |
| R-PWM0 | 45.3% | 34.7% | 19.0% | 13.3% | 14.7% |
| G-PWM0 | 48.0% | 52.0% | 48.0% | 32.0% | 5.3% |
| B-PWM0 | 6.7% | 13.3% | 33.0% | 54.7% | 80.0% |

As mentioned above, Table 1 shows mapping relationships between the duty cycles of the PWM signals R-PWM0, G-PWM0 and B-PWM0 and the mixed CCTs. It can be seen from the Table 1, in response to each mixed CCT, a sum of corresponding duty cycles of the PWM signals R-PWM0, G-PWM0 and B-PWM0 is 1, i.e., 100%.

Taking mixed light with a mixed CCT of 4000 Kelvins (K) obtained by driving, based on the PWM signals R-PWM0, G-PWM0 and B-PWM0, the red LED string, the green LED string and the blue LED string as an example, the corresponding duty cycles of the PWM signals R-PWM0, G-PWM0 and B-PWM0 are 19.0%, 48.0%, and 33.0% respectively, and waveforms of the PWM signals R-PWM0, G-PWM0 and B-PWM0 are as shown in FIG. 1B.

It can be seen from FIG. 1B that when the PWM signal R-PWM0 (or G-PWM0, or B-PWM0) is at a high level “1”, the red LED string (or the green LED string, or the blue LED string) lights up correspondingly; and when the PWM signal R-PWM0 (or G-PWM0, or B-PWM0) is at a low level “0”, the red LED string (or the green LED string, or the blue LED string) turns off correspondingly. Within a single cycle, the red, green and blue LED strings are in a lit-up state simultaneously for 19% of time of the cycle, and the red, green and blue LED strings are in an off state simultaneously for 52% of the time of the cycle; that is, the red, green and blue LED strings may be in a lit-up state simultaneously and in an off state simultaneously, which can cause the problem of flicker. Although the red, green and blue LED strings of the LED light source device as illustrated in FIG. 1A have the multiple flicker reduction circuits consisting of the flicker reduction chips U2, U3 and U4 and the capacitors C1, C2 and C3 added respectively, and the problem of flicker is reduced, the problem of flicker still exists, and the driving efficiency decreases by approximately 2% due to the multiple flicker reduction circuits.

Therefore, in order to effectively solve the problem of flicker occurred on the PWM signal adjustment, an embodiment of the disclosure provides a LED light source device and a driving method thereof.

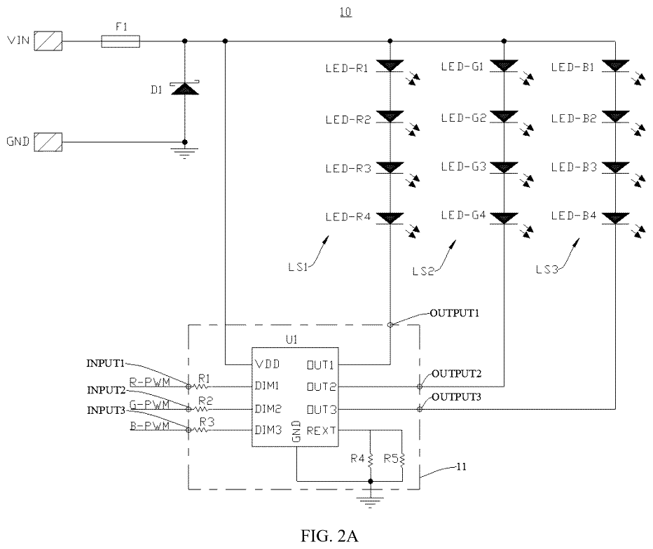

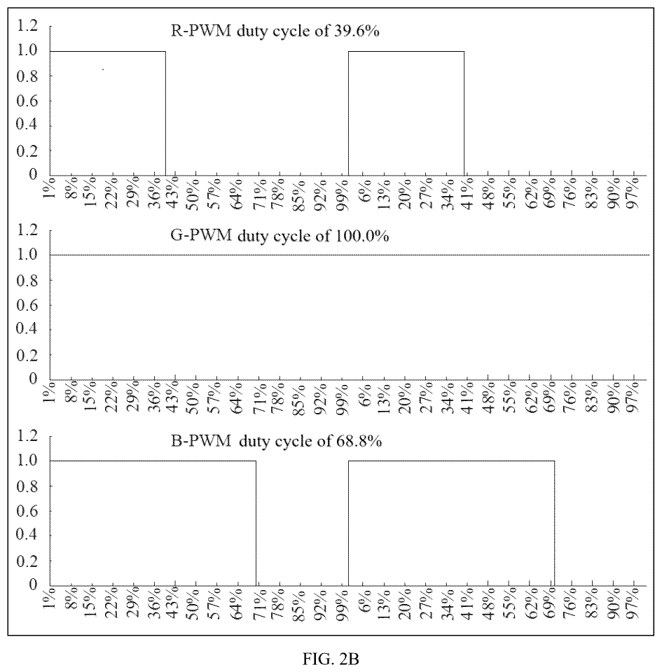

Specifically, as shown in FIG. 2A, the embodiment of the disclosure provides a LED light source device 10. The LED light source device 10 includes: a driving circuit 11, and N number of LED strings LS1, LS2 and LS3 of different colors, at this point, taking N=3 as an example. The driving circuit 11 includes N number of driving input ends INPUT1, INPUT2 and INPUT3, and N number of driving output ends OUTPUT1, OUTPUT2 and OUTPUT3. The driving circuit 11 is connected to a power input end GND (i.e., a first power input end). The LED strings LS1, LS2 and LS3 are connected between a power input end VIN (i.e., a second power input end) and the driving output ends OUTPUT1, OUTPUT2 and OUTPUT3 respectively. Specifically, the LED string LS1 includes multiple red LEDs LED-R1, LED-R2, LED-R3 and LED-R4 connected in series. An end of the LED string LS1 is connected to the power input end VIN, for example, connected to the power input end VIN through a protecting circuit such as a fuse F1, and another end of the LED string LS1 is connected to the driving output end OUTPUT1. The LED string LS2 includes multiple green LEDs LED-G1, LED-G2, LED-G3 and LED-G4 connected in series. An end of the LED string LS2 is connected to the power input end VIN, for example, connected to the power input end VIN through the protecting circuit such as the fuse F1, and another end of the LED string LS2 is connected to the driving output end OUTPUT2. The LED string LS3 includes multiple blue LEDs LED-B1, LED-B2, LED-B3 and LED-B4 connected in series. An end of the LED string LS3 is connected to the power input end VIN, for example, connected to the power input end VIN through the protecting circuit such as the fuse F1, and another end of the LED string LS3 is connected to the driving output end OUTPUT3. The driving input ends INPUT1, INPUT2 and INPUT3 are configured to receive target PWM signals R-PWM, G-PWM and B-PWM, respectively, to thereby make the driving circuit 11 drive, based on the target PWM signals R-PWM, G-PWM and B-PWM, the LED strings LS1, LS2 and LS3 connected to the driving output ends OUTPUT1, OUTPUT2 and OUTPUT3 to emit light for color mixing, thereby obtaining mixed light with a target mixed CCT.

TABLE 2
mapping relationship table between PWM signal
duty cycles and mixed CCTs

| | Mixed CCT | | | | |
|---|---|---|---|---|---|
| Target PWM signal | 2700K | 3000K | 4000K | 5000K | 6500K |
| R-PWM | 94.4% | 66.7% | 39.6% | 24.3% | 18.4% |
| G-PWM | 100.0% | 100.0% | 100.0% | 58.5% | 6.6% |
| B-PWM | 14.0% | 25.6% | 68.8% | 100.0% | 100.0% |

As mentioned above, Table 2 shows mapping relationships between the duty cycles of the target PWM signals R-PWM, G-PWM and B-PWM and the mixed CCTs. It can be seen from the Table 2, in response to each mixed CCT, a sum of corresponding duty cycles of the respective target PWM signals R-PWM, G-PWM and B-PWM is greater than 1 and less than N (N=3), and each of at least one of the corresponding duty cycles of the target PWM signals is 1 (i.e., 100%).

Taking mixed light with a mixed CCT of 4000 K obtained by driving the LED strings LS1, LS2 and LS3 based on the target PWM signals R-PWM, G-PWM and B-PWM as an example, the corresponding duty cycles of the target PWM signals R-PWM, G-PWM and B-PWM are 39.6%, 100.0%, and 68.8% respectively, and waveforms of the target PWM signals R-PWM, G-PWM and B-PWM are as shown in FIG. 2B. It can be seen from FIG. 2B that within a single cycle, the LED strings LS1, LS2 and LS3 are in a lit-up state simultaneously for 39.6% of time of the cycle, and the LED strings LS1, LS2 and LS3 are in an off state simultaneously for 0% of the time of the cycle; that is, the LED strings LS1, LS2 and LS3 may be in a lit-up state simultaneously but cannot be in an off state simultaneously, thereby solving the problem of flicker occurred on the PWM signal adjustment. In addition, since the flicker reduction circuits can be removed, the driving efficiency are further improved.

Furthermore, comparing the corresponding duty cycles of the respective PWM signals R-PWM0, G-PWM0 and B-PWM0 of 19.0%, 48.0%, and 33.0%, it can be known that the target PWM signal G-PWM can be obtained by converting the duty cycle of the PWM signal G-PWM0 with a maximum duty cycle to 1 (i.e., 100%), with a conversion ratio of 100.0%/48.0%, and other target PWM signals R-PWM0 and B-PWM0 can be obtained by converting the duty cycles of remaining PWM signals R-PWM0 and B-PWM0 based on the same conversion ratio, i.e., 19.0%×(100.0%/48.0%)≈39.6%, 33.0%×(100.0%/48.0%)≈68.8%. Similarly, the duty cycles of the PWM signals R-PWM0, G-PWM0 and B-PWM0 corresponding to other mixed CCTs in Table 1 can be converted to the corresponding duty cycles of the target PWM signals R-PWM, G-PWM and B-PWM in Table 2. In brief, in the embodiment, a duty cycle of each of at least one of the N number of target PWM signals R-PWM, G-PWM and B-PWM is 1, and a sum of duty cycles of the N number of target PWM signals R-PWM, G-PWM and B-PWM is greater than 1 and less than N; for example, when N=3, the sum of the duty cycles of the target PWM signals R-PWM, G-PWM and B-PWM is greater than 1 and less than 3.

Referring to FIG. 2A, in some embodiments, the driving circuit 11 includes a driving chip U1. N number of input pins DIM1, DIM2 and DIM3 of the driving chip U1 are connected to the driving input ends INPUT1, INPUT2 and INPUT3 through resistors R1, R2 and R3 respectively to receive the target PWM signals R-PWM, G-PWM and B-PWM respectively. N number of output pins OUT1, OUT2 and OUT3 of the driving chip U1 are connected to the driving output ends OUTPUT1, OUTPUT2 and OUTPUT3 respectively. A power supply pin VDD of the driving chip U1 is connected to the power input end VIN, for example, connected to the power input end VIN through the protecting circuit such as the fuse F1. A ground pin GND of the driving chip U1 is connected to the power input end GND. An external resistor connection pin REXT of the driving chip U1 is connected to the power input end GND through external resistors, such as external resistors R4 and R5 connected in parallel. It can be understood that, in some embodiments, the LED light source device 10 may include other peripheral circuits, such as a voltage regulating circuit like a Zener diode D1. An end of the Zener diode D1 is connected to the power input end VIN through a protecting circuit such as the fuse F1, and another end of the Zener diode D1 is connected to the power input end GND.

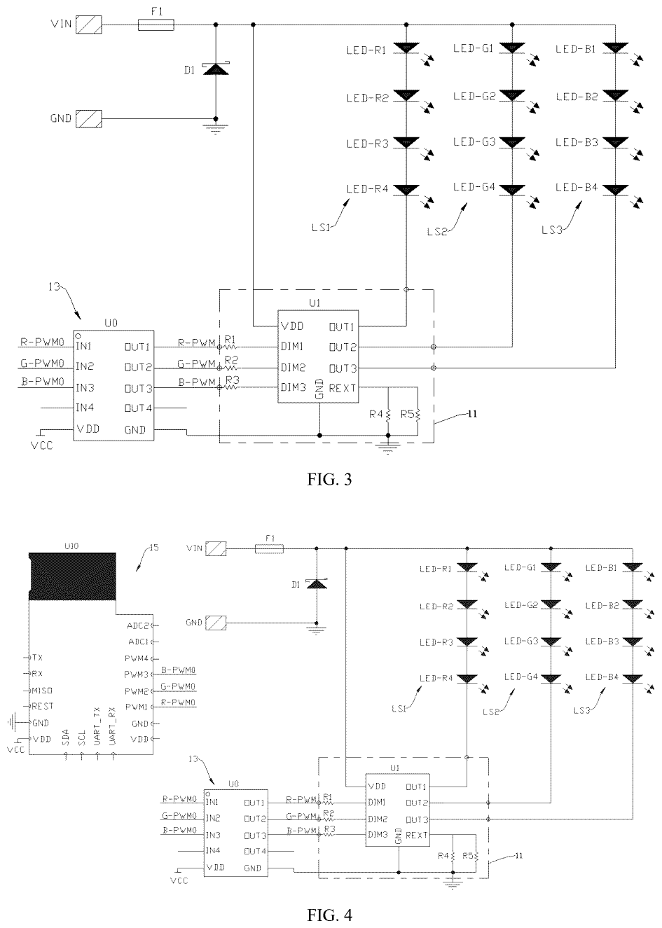

Referring to FIG. 3, in some embodiments, the LED light source device 10 illustrated in FIG. 2A may further include a waveform conversion circuit 13. The waveform conversion circuit 13 is configured to receive N number of initial PWM signals R-PWM0, G-PWM0 and B-PWM0, convert the initial PWM signals R-PWM0, G-PWM0 and B-PWM0 to the target PWM signals R-PWM, G-PWM and B-PWM, and output the target PWM signals R-PWM, G-PWM and B-PWM to the driving input ends INPUT1, INPUT2 and INPUT3 of the driving circuit 11 respectively. A sum of duty cycles of the respective initial PWM signals R-PWM0, G-PWM0 and B-PWM0 is equal to 1. The duty cycles of the respective initial PWM signals R-PWM0, G-PWM0 and B-PWM0 corresponding to different mixed CCTs can be searched in Table 1. Taking a mixed CCT of 4000 K as an example, specific operations of the “convert the initial PWM signals R-PWM0, G-PWM0 and B-PWM0 to the target PWM signals R-PWM, G-PWM and B-PWM” are as follows. The initial PWM signal G-PWM0 with a maximum duty cycle of the initial PWM signals R-PWM0, G-PWM0 and B-PWM0 is converted to the target PWM signal G-PWM with a duty cycle of 1, and a conversion ratio of 100.0%/48.0% is obtained; and remaining initial PWM signals R-PWM0 and B-PWM0 are converted to other target PWM signals R-PWM and B-PWM based on the conversion ratio of 100.0%/48.0%. In the embodiment, PWM signals provided to the LED light source device 10 may be same as the PWM signals provided to the LED light source device in the related art due to the waveform conversion circuit 13, thereby eliminating the need to redesign and/or reset a front-end circuit of the LED light source device 10.

Specifically, the waveform conversion circuit 13 may include a waveform conversion chip U0. The waveform conversion chip U0 can be a microcontroller unit (MCU) chip or other chips with processing capabilities. Input pins IN1, IN2 and IN3 of the waveform conversion chip U0 are configured to receive the initial PWM signals R-PWM0, G-PWM0 and B-PWM0 respectively. An input pin IN4 of the waveform conversion chip U0 is left unconnected. Output pins OUT1, OUT2 and OUT3 of the waveform conversion chip U0 are configured to output the target PWM signals R-PWM, G-PWM and B-PWM to the driving circuit 11 respectively. An output pin OUT4 of the waveform conversion chip U0 is left unconnected. A power supply pin VDD of the waveform conversion chip U0 is connected to a power voltage VCC. A ground pin GND of the waveform conversion chip U0 is connected to the power input end GND, i.e., the ground pin GND of the waveform conversion chip U0 is grounded.

Referring to FIG. 4, in some embodiments, the LED light source device 10 illustrated in FIG. 3 may further include an information processing circuit 15. The information processing circuit 15 is configured to receive/obtain color control information (such as CCT control information and/or chroma control information) via wireless or other methods (such as a wired method or button-triggered method), process the color control information to obtain the initial PWM signals R-PWM0, G-PWM0 and B-PWM0, and output the initial PWM signals R-PWM0, G-PWM0 and B-PWM0 to the waveform conversion circuit 13. For example, specific operations of the step “process the color control information to obtain the initial PWM signals R-PWM0, G-PWM0 and B-PWM0” are as follows. The initial PWM signals R-PWM0, G-PWM0 and B-PWM0 are obtained according to the color control information and the mapping relationship table between PWM signal duty cycles and mixed CCTs, where the mapping relationship table between PWM signal duty cycles and mixed CCTs adopts the Table 1, i.e., the information processing circuit 15 is stored with the Table 1. For example, when the color control information indicates a mixed CCT of 4000 K, the information processing circuit 15 obtains from the Table 1 that the duty cycles of the initial PWM signals R-PWM0, G-PWM0 and B-PWM0 corresponding to the mixed CCT of 4000 K are 19.0%, 48.0%, and 33.0% respectively; or, when the color control information indicates a mixed CCT of 2700 K, the information processing circuit 15 obtains from the Table 1 that the duty cycles of the initial PWM signals R-PWM0, G-PWM0 and B-PWM0 corresponding to the mixed CCT of 2700 K are 45.3%, 48.0%, and 6.7% respectively; or, when the color control information indicates a mixed CCT of 6500 K, the information processing circuit 15 obtains from the Table 1 that the duty cycles of the initial PWM signals R-PWM0, G-PWM0 and B-PWM0 corresponding to the mixed CCT of 6500 K are 14.7%, 5.3%, and 80.0% respectively. In the embodiment, a remote control of the mixed CCT of the LED light source device 10 can be achieved due to the information processing circuit 15, thereby enhancing the use convenience of the LED light source device 10.

More specifically, the information processing circuit 15 may include an intelligent control chip U10, which may be equipped with a wireless fidelity (Wi-Fi) module, a Bluetooth module, or other wireless communication modules, and thus the intelligent control chip U10 may communicate wirelessly with a control end such as a smartphone, via Wi-Fi, Bluetooth, or other wireless methods to receive the color control information, generate the initial PWM signals R-PWM0, G-PWM0 and B-PWM0 based on the color control information and the mapping relationship table between PWM signal duty cycles and mixed CCTs, and output the initial PWM signals R-PWM0, G-PWM0 and B-PWM0 to the waveform conversion circuit 13 by output pins PWM1, PWM2 and PWM3 of the intelligent control chip U10.

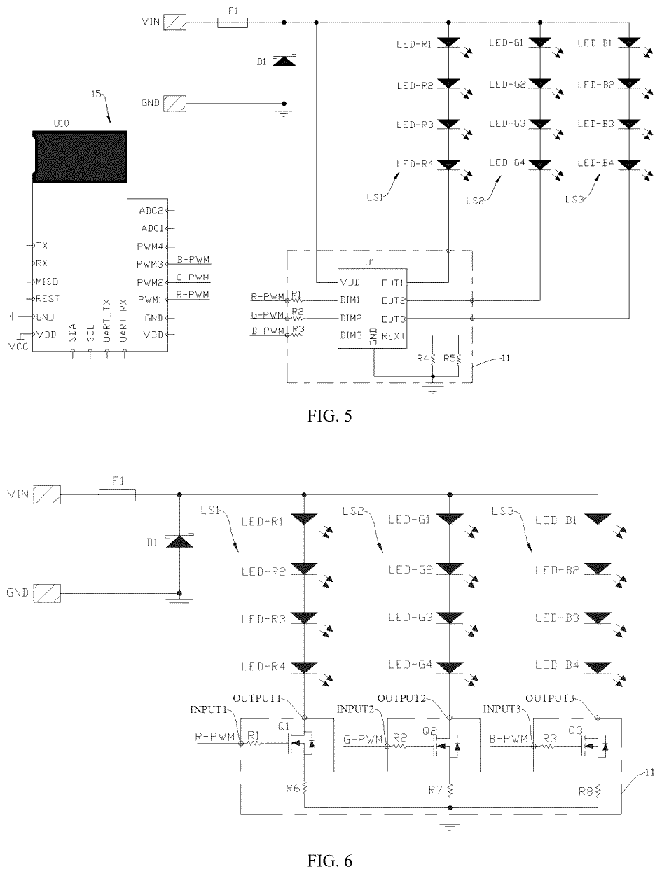

Referring to FIG. 5, in some embodiments, the LED light source device 10 illustrated in FIG. 2A may further include an information processing circuit 15. The information processing circuit 15 is configured to receive/obtain color control information (such as CCT control information and/or chroma control information) via wireless or other methods (such as a wired method or button-triggered method), process the color control information to obtain the target PWM signals R-PWM, G-PWM and B-PWM, and output the target PWM signals R-PWM, G-PWM and B-PWM to the driving circuit 11. For example, specific operations of the step “process the color control information to obtain the target PWM signals R-PWM, G-PWM and B-PWM” are as follows. The target PWM signals R-PWM, G-PWM and B-PWM are obtained according to the color control information and the mapping relationship table between PWM signal duty cycles and mixed CCTs, where the mapping relationship table between PWM signal duty cycles and mixed CCTs adopts the Table 2, i.e., the information processing circuit 15 is stored with the Table 2. For example, when the color control information indicates a mixed CCT of 4000 K, the information processing circuit 15 obtains from the Table 2 that the duty cycles of the target PWM signals R-PWM, G-PWM and B-PWM corresponding to the mixed CCT of 4000 K are 39.6%, 100.0%, and 68.8% respectively; or, when the color control information indicates a mixed CCT of 2700 K, the information processing circuit 15 obtains from the Table 2 that the duty cycles of the target PWM signals R-PWM, G-PWM and B-PWM corresponding to the mixed CCT of 2700 K are 94.4%, 100.0%, and 14.0% respectively; or, when the color control information indicates a mixed CCT of 6500 K, the information processing circuit 15 obtains from the Table 2 that the duty cycles of the target PWM signals R-PWM, G-PWM and B-PWM corresponding to the mixed CCT of 6500 K are 18.4%, 6.6%, and 100.0% respectively. In the embodiment, a remote control of the mixed CCT of the LED light source device 10 can be achieved due to the information processing circuit 15, thereby enhancing the use convenience of the LED light source device 10.

More specifically, the information processing circuit 15 may include an intelligent control chip U10, which may be equipped with a Wi-Fi module, a Bluetooth module, or other wireless communication modules, and thus the intelligent control chip U10 may communicate wirelessly with a control end such as a smartphone, via Wi-Fi, Bluetooth, or other wireless methods to receive the color control information, generate the target PWM signals R-PWM, G-PWM and B-PWM based on the color control information and the mapping relationship table between PWM signal duty cycles and mixed CCTs, and output the target PWM signals R-PWM, G-PWM and B-PWM to the driving circuit 11 by output pins PWM1, PWM2 and PWM3 of the intelligent control chip U10.

Referring to FIG. 6, in some embodiments, the driving circuit 11 of the LED light source device 10 in the aforementioned embodiments may include three (corresponding to N=3) three-terminal devices instead. Control terminals of the three-terminal devices are connected to the driving input ends INPUT1, INPUT2 and INPUT3 of the driving circuit 11 respectively through resistors R1, R2 and R3 to receive the target PWM signals R-PWM, G-PWM and B-PWM respectively. First current path terminals of the three-terminal devices are connected to the driving output ends OUTPUT1, OUTPUT2 and OUTPUT3 of the driving circuit 11 respectively, and second current path terminals of the three-terminal devices are connected to the power input end GND through resistors R6, R7 and R8 respectively. For example, the three-terminal devices are three field effect transistors Q1, Q2 and Q3. The control terminals of the three-terminal devices are gates of the field effect transistors Q1, Q2 and Q3, the first current path terminals of the three-terminal devices are drains of the field effect transistors Q1, Q2 and Q3, and the second current path terminals of the three-terminal devices are sources of the field effect transistors Q1, Q2 and Q3. In addition, the three-terminal devices are not limited to the field effect transistors, and can also be triodes, thyristors, or other three-terminal devices. In some embodiments, the resistors R6, R7 and R8 can be replaced with wires of specific resistances.

As shown in FIG. 7, in some embodiments, the number of the N number of LED strings of the LED light source device 10 is not limited to N=3, and it may also be N=4, such as four LED strings LS1, LS2 LS3 and LS4. For example, the LED string LS1 includes multiple red LEDS LED-R1, LED-R2, LED-R3 and LED-R4 connected in series. An end of the LED string LS1 is connected to the power input end VIN, for example, connected to the power input end VIN through the protecting circuit such as the fuse F1, and another end of the LED string LS1 is connected to the driving output end OUTPUT1. The LED string LS2 includes multiple green LEDs LED-G1, LED-G2, LED-G3 and LED-G4 connected in series. An end of the LED string LS2 is connected to the power input end VIN, for example, connected to the power input end VIN through the protecting circuit such as the fuse F1, and another end of the LED string LS2 is connected to the driving output end OUTPUT2. The LED string LS3 includes multiple blue LEDs LED-B1, LED-B2, LED-B3 and LED-B4 connected in series. An end of the LED string LS3 is connected to the power input end VIN, for example, connected to the power input end VIN through the protecting circuit such as the fuse F1, and another end of the LED string LS3 is connected to the driving output end OUTPUT3. The LED string LS4 includes multiple white LEDS LED-W1, LED-W2, LED-W3 and LED-W4 connected in series. An end of the LED string LS4 is connected to the power input end VIN, for example, connected to the power input end VIN through the protecting circuit such as the fuse F1, and another end of the LED string LS4 is connected to a driving output end OUTPUT4 of the driving circuit 11.

In addition, in a case that a single driving chip such as each of driving chips U11 and U12 of the driving circuit 11 has only three input pins DIM1, DIM2 and DIM3 and three output pins OUT1, OUT2 and OUT3 in FIG. 7, the two driving chips U11 and U12 can be used to jointly drive the four LED strings LS1, LS2, LS3 and LS4. Specifically, the input pins DIM1 and DIM2 of the driving chip U11 are connected to resistors R1 and R2 respectively and configured to receive the target PWM signals R-PWM and G-PWM, the input pin DIM3 of the driving chip U11 is left unconnected, the output pins OUT1 and OUT2 of the driving chip U11 are connected to the driving output ends OUTPUT1 and OUTPUT2 of the driving circuit 11 respectively, the output pin OUT3 of the driving chip U11 is left unconnected, a power supply pin VDD of the driving chip U11 is connected to the power input end VIN, a ground pin GND of the driving chip U11 is connected to the power input end GND, and an external resistor connection pin REXT of the driving chip U11 is connected to the power input end GND through external resistors such as the external resistors R4 and R5 connected in parallel. The input pins DIM1 and DIM2 of the driving chip U12 are connected to resistors R3 and R9 respectively and configured to receive the target PWM signals B-PWM and W-PWM, the input pin DIM3 of the driving chip U12 is left unconnected, output pins OUT1 and OUT2 of the driving chip U12 are connected to the driving output ends OUTPUT3 and OUTPUT4 of the driving circuit 11 respectively, the output pin OUT3 of the driving chip U12 is left unconnected, a power supply pin VDD of the driving chip U12 is connected to the power input end VIN, a ground pin GND of the driving chip U12 is connected to the power input end GND, and an external resistor connection pin REXT of the driving chip U12 is connected to the power input end GND through external resistors such as external resistors R10 and R11 connected in parallel.

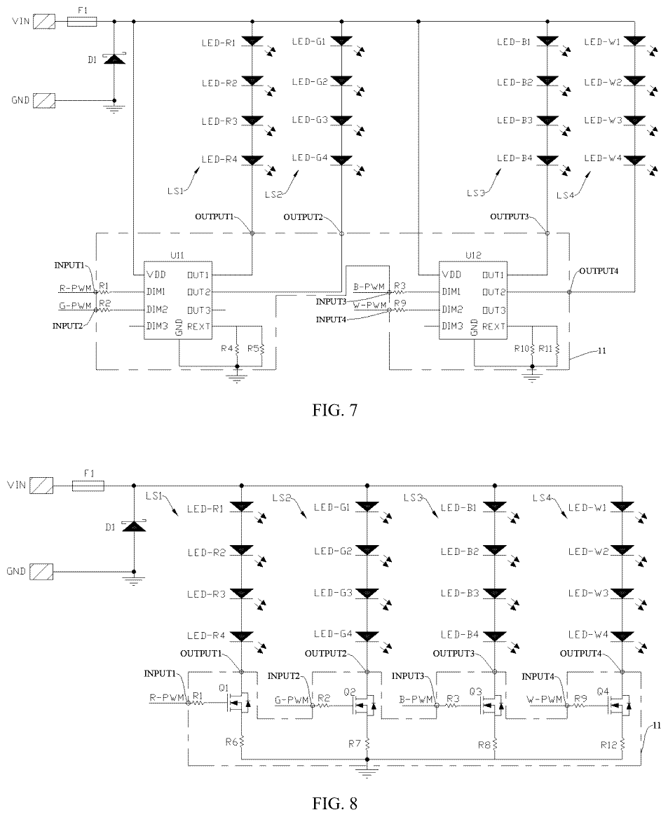

Referring to FIG. 8, in some embodiments, the driving circuit 11 of the LED light source device 10 in FIG. 7 may include four (corresponding to N=4) three-terminal devices instead. Control terminals of the four three-terminal devices are connected to four driving input ends INPUT1, INPUT2, INPUT3 and INPUT4 of the driving circuit 11 respectively through resistors R1, R2, R3 and R9 to receive the four target PWM signals R-PWM, G-PWM, B-PWM and W-PWM respectively. First current path terminals of the four three-terminal devices are connected to four driving output ends OUTPUT1, OUTPUT2, OUTPUT3 and OUTPUT4 of the driving circuit 11 respectively, and second current path terminals of the four three-terminal devices are connected to the power input end GND through resistors R6, R7, R8 and R12 respectively. For example, the four three-terminal devices are four field effect transistors Q1, Q2, Q3 and Q4. The control terminals of the four three-terminal devices are gates of the field effect transistors Q1, Q2, Q3 and Q4, the first current path terminals of the four three-terminal devices are drains of the field effect transistors Q1, Q2, Q3 and Q4, and the second current path terminals of the four three-terminal devices are sources of the field effect transistors Q1, Q2, Q3 and Q4. In addition, the four three-terminal devices are not limited to the field effect transistors, and can also be triodes, thyristors, or other three-terminal devices. In some embodiments, the resistors R6, R7, R8 and R12 can be replaced with wires of specific resistances.

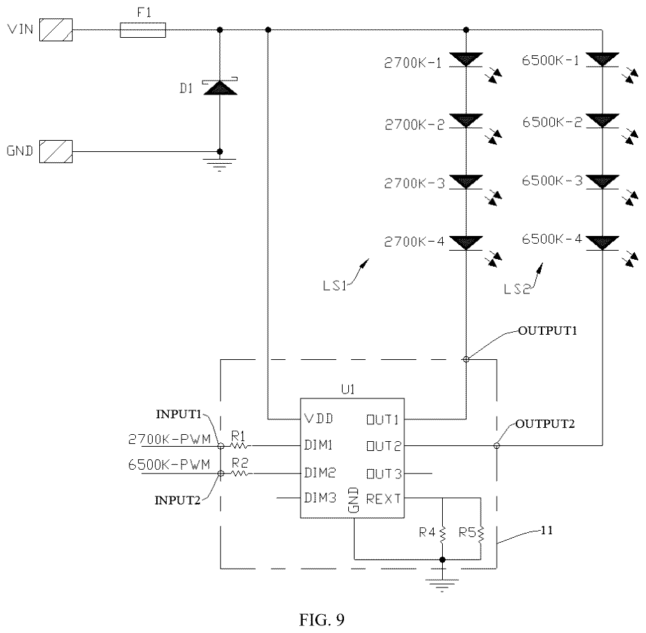

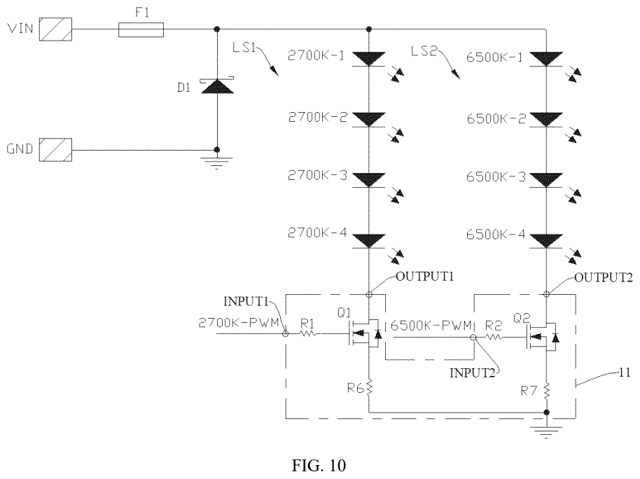

As shown in FIG. 9, in some embodiments, the number of the N number of LED strings of the LED light source device 10 is not limited to N=3, and it may also be N=2, such as two LED strings LS1 and LS2 with different colors. For example, the LED string LS1 includes multiple warm white LEDs 2700K-1, 2700K-2, 2700K-3 and 2700K-4 connected in series. An end of the LED string LS1 is connected to the power input end VIN, for example, connected to the power input end VIN through the protecting circuit such as the fuse F1, and another end of the LED string LS1 is connected to the driving output end OUTPUT1. The LED string LS2 includes multiple cold white LEDs 6500K-1, 6500K-2, 6500K-3 and 6500K-4 connected in series. An end of the LED string LS2 is connected to the power input end VIN, for example, connected to the power input end VIN through the protecting circuit such as the fuse F1, and another end of the LED string LS2 is connected to the driving output end OUTPUT2.

In addition, in a case that a single driving chip such as the driving chip U11 of the driving circuit 11 has three input pins DIM1, DIM2 and DIM3 and three output pins OUT1, OUT2 and OUT3 in FIG. 9, the input pins DIM1 and DIM2 of the driving chip U11 are connected to resistors R1 and R2 respectively and configured to receive the target PWM signals 2700K-PWM and 6500K-PWM, the input pin DIM3 of the driving chip U11 is left unconnected, the output pins OUT1 and OUT2 of the driving chip U11 are connected to the driving output ends OUTPUT1 and OUTPUT2 of the driving circuit 11 respectively, the output pin OUT3 of the driving chip U11 is left unconnected, a power supply pin VDD of the driving chip U11 is connected to the power input end VIN, a ground pin GND of the driving chip U11 is connected to the power input end GND, and an external resistor connection pin REXT of the driving chip U11 is connected to the power input end GND through external resistors such as the external resistors R4 and R5 connected in parallel.

Referring to FIG. 10, in some embodiments, the driving circuit 11 of the LED light source device 10 in FIG. 9 may include two (corresponding to N=2) three-terminal devices instead. Control terminals of the two three-terminal devices are connected to two driving input ends INPUT1 and INPUT2 of the driving circuit 11 respectively through resistors R1 and R2 to receive the two target PWM signals 2700K-PWM and 6500K-PWM respectively. First current path terminals of the two three-terminal devices are connected to two driving output ends OUTPUT1 and OUTPUT2 of the driving circuit 11 respectively, and second current path terminals of the two three-terminal devices are connected to the power input end GND through resistors R6 and R7 respectively. For example, the two three-terminal devices are two field effect transistors Q1 and Q2. The control terminals of the two three-terminal devices are gates of the field effect transistors Q1 and Q2, the first current path terminals of the two three-terminal devices are drains of the field effect transistors Q1 and Q2, and the second current path terminals of the two three-terminal devices are sources of the field effect transistors Q1 and Q2. In addition, the two three-terminal devices are not limited to the field effect transistors, and can also be triodes, thyristors, or other three-terminal devices. In some embodiments, the resistors R6 and R7 can be replaced with wires of specific resistances.

It is worth noting that, the number of the N number of LED strings of the LED light source device 10 provided by the embodiments of the disclosure is not limited to N=2, N=3 and N=4, it may also be N=5 or N=6 etc. Correspondingly, the number of the target PWM signals is not limited to 2, 3, and 4, it may also be more, such as 5 or 6.

Moreover, a LED string with a single color can consist of a single LED, or can include multiple LEDs with the same color connected in series. Additionally, it can be multiple LED sub-strings connected in parallel with the same color connected to a same drive output end of the drive circuit 11, and a single LED sub-string can consist of a single LED or include multiple LEDs with the same color connected in series.

In addition, the embodiment of the disclosure provides the driving method of the LED light source device, adapt to the LED light source device including N number of LED strings of different colors, and N is an integer greater than 1. Specifically, the driving method includes the following steps (i) to (ii).
(i) N number of target PWM signals are received, where a duty cycle of each of at least one of the N number of target PWM signals is 1, and a sum of duty cycles of the respective N number of target PWM signals is greater than 1 and less than N.
(ii) The N number of LED strings are driven to emit light for color mixing based on the N number of target PWM signals respectively.

Exemplarily, the N number of target PWM signals can be the three target PWM signals R-PWM, G-PWM and B-PWM received by the driving circuit 11 in FIG. 2A, and FIG. 3 to FIG. 6, or the four target PWM signals R-PWM, G-PWM, B-PWM and W-PWM received by the driving circuit 11 in FIG. 7 and FIG. 8, or the two target PWM signals 2700K-PWM and 6500K-PWM received by the driving circuit 11 in FIG. 9 and FIG. 10, or more target PWM signals. Correspondingly, the driving circuit 11 may drive the N number of LED strings respectively based on the N number of target PWM signals received, such as, drive the three LED strings LS1, LS2 and LS3 respectively in FIG. 2A, and FIG. 3 to FIG. 6, or drive the four LED strings LS1, LS2, LS3 and LS4 respectively in FIG. 7, and FIG. 8, or drive the two LED strings LS1 and LS2 respectively in FIG. 9, and FIG. 10, or drive more LED strings to emit light for color mixing to obtain the mixed light with the target mixed CCT.

In some embodiments, the driving method further includes the following steps: N number of initial PWM signals are received, where a sum of duty cycles of the N number of initial PWM signals is equal to 1; and the N number of initial PWM signals are converted to the N number of target PWM signals respectively. Exemplarily, the N number of initial PWM signals may be the three initial PWM signals R-PWM0, G-PWM0 and B-PWM0 received by the waveform conversion circuit 13 in FIG. 3 and FIG. 4, or other number of the initial PWM signals, such as two, four or more initial PWM signals. Moreover, the waveform conversion circuit 13 may convert the N number of initial PWM signals such as R-PWM0, G-PWM0 and B-PWM0 received to the N number of target PWM signals such as R-PWM, G-PWM and B-PWM.

In some embodiments, the step “the N number of initial PWM signals are converted to the N number of target PWM signals respectively” specifically includes the following steps: one of the N number of initial PWM signals with a maximum duty cycle is converted to one of the N number of target PWM signals with a duty cycle of 1, and a converting ratio is obtained; and each remaining initial PWM signal of the N number of initial PWM signals are converted to one of the other(s) of the target PWM signals based on the converting ratio. Exemplarily, taking a mixed CCT of 4000 K as an example, in response to three (corresponding to N=3) LED strings LS1, LS2 and LS3, it can be known from the Table 1 that, the corresponding duty cycles of the initial PWM signals R-PWM0, G-PWM0 and B-PWM0 of 19.0%, 48.0%, and 33.0%, the initial PWM signal G-PWM0 with a maximum duty cycle of 48.0% is converted to the target PWM signal G-PWM with a duty cycle of 1 and a conversion ratio of 100.0%/48.0% is obtained. Other target PWM signals R-PWM0 and B-PWM0 can be obtained by converting the duty cycles of remaining PWM signals R-PWM0 and B-PWM0 based on the same conversion ratio, i.e., 19.0%×(100.0%/48.0%)≈39.6%, 33.0%×(100.0%/48.0%)≈68.8%. Similarly, the duty cycles of the PWM signals R-PWM0, G-PWM0 and B-PWM0 corresponding to other mixed CCTs in Table 1 can be converted to the corresponding duty cycles of the target PWM signals R-PWM, G-PWM and B-PWM in Table 2.

In some embodiments, the driving method may further include the following steps: color control information is received; and the color control information is processed to obtain the N number of initial PWM signals. Exemplarily, the color control information is received by the information processing circuit 15 through a wireless method such as Wi-Fi and Bluetooth. The color control information includes information indicating a mixed CCT value. Then, the color control information is processed by the information processing circuit 15 to obtain the N number of initial PWM signals such as R-PWM0, G-PWM0 and B-PWM0.

In some embodiments, the step “the color control information is processed to obtain the N number of initial PWM signals” specifically includes: the N number of target PWM signals are obtain based on the color control information and a first mapping relationship table. The first mapping relationship table includes at least one mixed CCT and duty cycles of respective N number of PWM signals corresponding to each of the at least one mixed CCT, and a sum of the duty cycles of the N number of PWM signals is equal to 1. Exemplarily, the first mapping relationship table can be the mapping relationship table between initial PWM signal duty cycles and mixed CCTs stored in the information processing circuit 15 in FIG. 4, for the LED light source device 10 including three (corresponding to N=3) LED strings of different colors, the mapping relationship table between initial PWM signal duty cycles and mixed CCTs may use the Table 1, but the embodiments of the disclosure are not limited to this.

In some embodiments, the driving method may further include the following steps: color control information is received; and the color control information is processed to obtain the N number of target PWM signals. Exemplarily, the color control information is received by the information processing circuit 15 through a wireless method such as Wi-Fi and Bluetooth. The color control information includes information indicating a mixed CCT value. Then, the color control information is processed by the information processing circuit 15 to obtain the N number of target PWM signals such as R-PWM, G-PWM and B-PWM.

In some embodiments, the step “the color control information is processed to obtain the N number of target PWM signals” specifically includes: the N number of target PWM signals are obtained based on the color control information and a second mapping relationship table.

The second mapping relationship table includes at least one mixed CCT and duty cycles of respective N number of PWM signals corresponding to each of the at least one mixed CCT, a sum of the duty cycles of the respective N number of PWM signals is greater than 1, and a duty cycle of each of at least one of the N number of PWM signals is equal to 1. Exemplarily, the second mapping relationship table can be the mapping relationship table between target PWM signal duty cycles and mixed CCTs stored in the information processing circuit 15 in FIG. 5, for the LED light source device 10 including three (corresponding to N=3) LED strings of different colors, the mapping relationship table between target PWM signal duty cycles and mixed CCTs may use the Table 2, but the embodiments of the disclosure are not limited to this.

The above description is only the illustrated embodiments of the disclosure and does not limit the disclosure in any form. Although the disclosure is disclosed in the illustrated embodiments above, it is not intended to limit the disclosure. Any skilled in the art who is familiar with this field can use the disclosed technical content to make slight changes or amendments to equivalent embodiments without departing from the scope of the technical solution of the disclosure. Any simple amendments, equivalent changes, and modifications made to the above embodiments based on the technical essence of the disclosure without departing from the technical solution of the disclosure are still within the scope of the technical solution of the disclosure.

What is claimed is:

1. A light-emitting diode (LED) light source device, comprising:
a driving circuit, comprising N number of driving input ends and N number of driving output ends, wherein the driving circuit is connected to a first power input end, and N is an integer greater than 1; and
N number of LED strings of different colors, connected between a second power input end and the N number of driving output ends respectively;
wherein the N number of driving input ends are configured to receive N number of target pulse-width modulation (PWM) signals respectively, to thereby make the driving circuit, based on the N number of target PWM signals, drive the N number of LED strings of different colors respectively connected to the N number of driving output ends to emit light for color mixing, a sum of duty cycles of the respective N number of target PWM signals is greater than 1 and less than N, and the duty cycle of each of at least one of the N number of target PWM signals is 1.

2. The LED light source device as claimed in claim 1, further comprising:
a waveform conversion circuit, configured to receive N number of initial PWM signals, convert the N number of initial PWM signals to the N number of target PWM signals, and output the N number of target PWM signals to the N number of driving input ends of the driving circuit respectively; wherein a sum of duty cycles of the respective N number of initial PWM signals is equal to 1.

3. The LED light source device as claimed in claim 2, further comprising:
an information processing circuit, configured to receive color control information, process the color control information to obtain the N number of initial PWM signals, and output the N number of initial PWM signals to the waveform conversion circuit.

4. The LED light source device as claimed in claim 1, further comprising:
an information processing circuit, configured to receive color control information, process the color control information to obtain the N number of target PWM signals, and output the N number of target PWM signals to the N number of driving input ends of the driving circuit respectively.

5. The LED light source device as claimed in claim 1, wherein the driving circuit comprises a driving chip, and the driving chip comprises:
N number of input pins, connected to the N number of driving input ends through resistors respectively to receive the N number of target PWM signals respectively;
N number of output pins, connected to the N number of driving output ends respectively;
a power supply pin, connected to the second power input end;
a ground pin, connected to the first power input end; and
an external resistor connection pin, connected to the first power input end through external resistors.

6. The LED light source device as claimed in claim 2, wherein the driving circuit comprises a driving chip, and the driving chip comprises:
N number of input pins, connected to the N number of driving input ends through resistors respectively to receive the N number of target PWM signals respectively;
N number of output pins, connected to the N number of driving output ends respectively;
A power supply pin, connected to the second power input end;
a ground pin, connected to the first power input end; and
an external resistor connection pin, connected to the first power input end through external resistors.

7. The LED light source device as claimed in claim 3, wherein the driving circuit comprises a driving chip, and the driving chip comprises:
N number of input pins, connected to the N number of driving input ends through resistors respectively to receive the N number of target PWM signals respectively;
N number of output pins, connected to the N number of driving output ends respectively;
a power supply pin, connected to the second power input end;
a ground pin, connected to the first power input end; and
an external resistor connection pin, connected to the first power input end through external resistors.

8. The LED light source device as claimed in claim 4, wherein the driving circuit comprises a driving chip, the driving chip comprises:
N number of input pins, connected to the N number of driving input ends through resistors respectively to receive the N number of target PWM signals respectively;
N number of output pins, connected to the N number of driving output ends respectively;
a power supply pin, connected to the second power input end;
a ground pin, connected to the first power input end; and
an external resistor connection pin, connected to the first power input end through external resistors.

9. The LED light source device as claimed in claim 1, wherein the driving circuit comprises N number of three-terminal devices, control terminals of the respective N number of three-terminal devices are connected to the N number of driving input ends respectively through resistors to receive the N number of target PWM signals respectively, first current path terminals of the respective N number of three-terminal devices are connected to the N number of driving output ends respectively, and second current path terminals of the N number of three-terminal devices are connected to the first power input end through resistors respectively.

10. The LED light source device as claimed in claim 2, wherein the driving circuit comprises: N number of three-terminal devices, control terminals of the N number of three-terminal devices are connected to the respective N number of driving input ends respectively through resistors to receive the N number of target PWM signals respectively, first current path terminals of the N number of three-terminal devices are connected to the N number of driving output ends respectively, and second current path terminals of the N number of three-terminal devices are connected to the first power input end through resistors respectively.

11. The LED light source device as claimed in claim 3, wherein the driving circuit comprises: N number of three-terminal devices, control terminals of the N number of three-terminal devices are connected to the respective N number of driving input ends respectively through resistors to receive the N number of target PWM signals respectively, first current path terminals of the N number of three-terminal devices are connected to the N number of driving output ends respectively, and second current path terminals of the N number of three-terminal devices are connected to the first power input end through resistors respectively.

12. The LED light source device as claimed in claim 4, wherein the driving circuit comprises: N number of three-terminal devices, control terminals of the N number of three-terminal devices are connected to the respective N number of driving input ends respectively through resistors to receive the N number of target PWM signals respectively, first current path terminals of the N number of three-terminal devices are connected to the N number of driving output ends respectively, and second current path terminals of the N number of three-terminal devices are connected to the first power input end through resistors respectively.

13. The LED light source device as claimed in claim 3, wherein the information processing circuit is stored with a first mapping relationship table, and the first mapping relationship table comprises at least one mixed correlated color temperature and duty cycles of respective N number of PWM signals corresponding to each of the at least one mixed correlated color temperature, and a sum of the duty cycles of the respective N number of PWM signals is equal to 1.

14. The LED light source device as claimed in claim 4, wherein the information processing circuit is stored with a second mapping relationship table, and the second mapping relationship table comprises at least one mixed correlated color temperature and duty cycles of respective N number of PWM signals corresponding to each of the at least one mixed correlated color temperature, a sum of the duty cycles of the respective N number of PWM signals is greater than 1, and the duty cycle of each of at least one of the N number of PWM signals is equal to 1.

15. A driving method of a LED light source device, wherein the LED light source device comprises: N number of LED strings of different colors, and N is an integer greater than 1; the driving method comprising:
receiving N number of target PWM signals, wherein a duty cycle of each of at least one of the N number of target PWM signals is 1, and a sum of duty cycles of the respective N number of target PWM signals is greater than 1 and less than N; and
driving, based on the N number of target PWM signals, the N number of LED strings of different colors to emit light for color mixing, respectively.

16. The driving method as claimed in claim 15, further comprising:
receiving N number of initial PWM signals, wherein a sum of duty cycles of the N number of initial PWM signals is equal to 1; and
converting the N number of initial PWM signals to the N number of target PWM signals respectively.

17. The driving method as claimed in claim 16, wherein the converting the N number of initial PWM signals to the N number of target PWM signals respectively, specifically comprises:
converting one of the N number of initial PWM signals with a maximum duty cycle to one of the N number of target PWM signals with a duty cycle of 1, and obtaining a converting ratio; and
converting, based on the converting ratio, each remaining initial PWM signal of the N number of initial PWM signals to one of the other(s) of the target PWM signals.

18. The driving method as claimed in claim 16, further comprising:
receiving color control information; and
processing the color control information to obtain the N number of initial PWM signals, specifically comprising:
obtaining the N number of initial PWM signals based on the color control information and a first mapping relationship table, wherein the first mapping relationship table comprises at least one mixed correlated color temperature and duty cycles of respective N number of PWM signals corresponding to each of the at least one mixed correlated color temperature, and a sum of the duty cycles of the respective N number of PWM signals is equal to 1.

19. The driving method as claimed in claim 17, further comprising:
receiving color control information; and
processing the color control information to obtain the N number of initial PWM signals, specifically comprising:
obtaining the N number of initial PWM signals based on the color control information and a first mapping relationship table, wherein the first mapping relationship table comprises at least one mixed correlated color temperature and duty cycles of respective N number of PWM signals corresponding to each of the at least one mixed correlated color temperature, and a sum of the duty cycles of the respective N number of PWM signals is equal to 1.

20. The driving method as claimed in claim 15, further comprising:
receiving color control information; and
processing the color control information to obtain the N number of target PWM signals, specifically comprising:
obtaining the N number of target PWM signals based on the color control information and a second mapping relationship table, wherein the second mapping relationship table comprises at least one mixed correlated color temperature and duty cycles of respective N number of PWM signals corresponding to each of the at least one mixed correlated color temperature, a sum of the duty cycles of the respective N number of PWM signals is greater than 1, and the duty cycle of each of at least one of the N number of PWM signals is equal to 1.
